(19) United States
(12) Patent Application Publication
(10) Pub. No.: US 2026/0118320 A1
(43) Pub. Date: Apr. 30, 2026

(54) Method and system for measuring a variation in a dimension of a mechanical part

(71) Applicant: COMMISSARIAT A L’ENERGIE ATOMIQUE ET AUX ENERGIES ALTERNATIVES, PARIS (FR)

(72) Inventors: Nicolas GARRAUD, GRENOBLE (FR); Julien MARIANNE, GRENOBLE (FR); Baptiste ALESSANDRI, GRENOBLE (FR); Esteban CABANILLAS, GRENOBLE (FR); Jean-Yves BURLET, GRENOBLE (FR)

(21) Appl. No.: 18/984,785

(22) Filed: Dec. 17, 2024

(30) Foreign Application Priority Data
Dec. 20, 2023 (FR) 2314667

(51) Int. Cl. G01N 29/09; G01B 5/02; G01N 29/24; G01N 29/44

(52) U.S. Cl. CPC G01N 29/09; G01B 5/02; G01N 29/2437; G01N 29/4472; G01N 2291/018; G01N 2291/02854; G01N 2291/102; G01N 2291/2691

(57) ABSTRACT

A method for measuring a variation in a dimension (L) of a mechanical part along a direction called the longitudinal direction (x), includes the steps of: a) providing at least a first and second piezoelectric transducer arranged at two different positions along the longitudinal direction and acoustically coupled via the mechanical part; b) performing, at different times, a plurality of electric measurements in order to determine at least one value of an electric parameter dependent on an off-diagonal term of an impedance matrix of an electric quadrupole modeling the assembly formed by the acoustically coupled first and second piezoelectric transducers; and c) deducing from the results of the electric measurements the variation in the dimension of the mechanical part. A system for implementing this method is also provided.

The invention relates to the field of ultrasonic non-destructive testing. It is in particular, but not exclusively, applicable to measurement of the tightness of screwed fastening systems during industrial assembly of parts.

It is known to use acoustic techniques to accurately and dynamically measure the tightness of screwed fastening systems during industrial assembly of parts by an acoustic method.

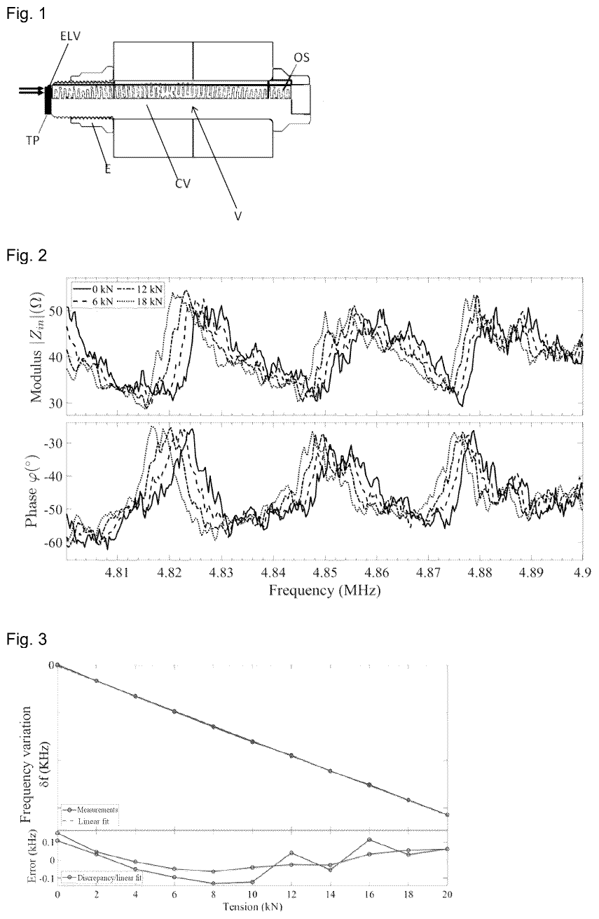

As illustrated in FIG. 1, this may be achieved by fastening, to one end ELV of a fastening means (bolt) V, a piezoelectric transducer TP and exciting it by means of a sinusoidal voltage. The transducer generates, in the body CV of the fastening means, standing acoustic waves OS, the form of which depends on the length of the structure. In turn, these acoustic waves modify the impedance of the piezoelectric transducer TP, and this impedance may be measured at the same time as the transducer is excited. If the phase and modulus of the complex impedance of the transducer are plotted as a function of frequency, peaks corresponding to the acoustic frequencies of resonance of the structure can be observed.

As the fastening system is tightened (for example, by screwing a nut E), its length changes, and its resonant frequencies therewith. A shift in the frequency of the peaks of the impedance of the transducer is then observed. This is illustrated in FIG. 2, in which 4 impedance curves—corresponding to tensions of 0, 6 kN, 12 kN and 18 kN—have been superposed. FIG. 3 shows that the relationship between the applied voltage and the frequency shift δf of the impedance peaks is substantially linear, with an error of the order of 1% (the two curves in the bottom part correspond to the deviation from a linear relationship as tension is applied and released).

The tightness of the nut may be controlled, automatically if needs be, by means of this measurement of mechanical tension, allowing pre-tensioning to be controlled more accurately than possible using a simple mechanical measurement of the tightening torque applied.

This technique, which is known in the literature as “impedance frequency shift” (IFS), is for example described in (Heyman 1977), (Smith 1980), (Joshi 1984), (Shao 2016) and (Dreisbach 2023).

As may be seen, however, the impedance peaks are quite wide with respect to their spacing, this making it difficult to accurately determine their spacing and, therefore, the variation in the length of the fastening element. In practice, it is necessary to employ frequency analysis, which requires acquisition over a number of periods, and therefore a wide spectral band and a long acquisition time.

A competitor of IFS is a technique based on measurement of the time-of-flight (ToF) of an acoustic wave. As in the case of the IFS, a piezoelectric transducer is attached to the structure and excited to generate acoustic waves therein. Unlike IFS however, the transducer is excited with a voltage pulse generating a time-limited acoustic wave. The wave propagates into the structure before returning to the transducer, thereby making a round trip. The transducer is then used as a sensor, its voltage, which varies when the acoustic wave returns, being monitored. The time between transmission and reception depends on the speed of the wave (which is obtained by prior calibration) and the length of the structure. ToF is a technique that is well-known and widely used in the art. However, it has a number of drawbacks, in particular including the need to use fast electronics to generate short pulses, and pulses of voltage of the order of a few hundred volts (in contrast to a few volts in the case of the IFS).

The invention aims to overcome at least some of the aforementioned drawbacks of the prior art. More particularly, it aims to improve the accuracy and sensitivity of the IFS technique without notably complicating its implementation.

According to the invention, this aim is achieved by virtue of conjoint use of two piezoelectric transducers acoustically coupled through the mechanical part the length of which has to be measured. The assembly consisting of the two acoustically coupled transducers may be modeled by an electric quadrupole, characterized by an impedance matrix Z. Measurement of the off-diagonal element Z₁₂ of this matrix (or another electric parameter proportional to this element) as a function of frequency makes it possible to estimate a variation in the length of the mechanical part, as in the standard IFS technique. The advantage of the invention lies in the fact that, as will be shown below, the impedance peaks are far more pronounced and narrower than in the conventional case in which a single transducer is used.

One subject of the invention is therefore a method for measuring a variation in a dimension of a mechanical part along a direction called the longitudinal direction, comprising the steps of:
a) providing at least a first and second piezoelectric transducer arranged at two different positions along said longitudinal direction and acoustically coupled via said mechanical part;
b) performing, at different times, a plurality of electric measurements in order to determine at least one value of an electric parameter dependent on an off-diagonal term of an impedance matrix of an electric quadrupole modeling the assembly formed by the acoustically coupled first and second piezoelectric transducers; and
c) deducing from the results of said electric measurements said variation in the dimension of the mechanical part.

According to particular embodiments of such a method:
Each said electric measurement of step b) may comprise the sub-steps of:
b1) applying a first electric excitation signal to said first piezoelectric transducer in order to generate acoustic waves propagating through the mechanical part to the second transducer, while keeping the second piezoelectric transducer open circuit, and measuring at the same time the input impedance of said first piezoelectric transducer;
b2) applying a second electric excitation signal to said first piezoelectric transducer in order to generate acoustic waves propagating through the mechanical part to the second transducer, while keeping the second piezoelectric transducer short-circuited, and measuring at the same time the input impedance of said first piezoelectric transducer;
b3) calculating the value of said electric parameter from the input impedances thus measured;
the order of sub-steps b1) and b2) being able to be reversed.

Said electric parameter may be the phase difference of the input impedances measured in sub-steps b1) and b2).

The second piezoelectric transducer may comprise two electric terminals connected together by a pair of back-to-back diodes in parallel, the first excitation signal being sufficiently weak for the acoustic waves generated to induce, across the terminals of said second piezoelectric transducer, a voltage lower than a threshold of said diodes, which may then be likened to an open circuit, and the second excitation signal being strong enough for the acoustic waves generated to induce, across the terminals of said second piezoelectric transducer, a voltage greater than a threshold of said diodes, which may then be likened to a short-circuit.

Step b) may comprise determining the value of said parameter as a function of frequency.

Step c) may comprise identifying peaks in the value of said electric parameter as a function of frequency, the variation in a dimension of the mechanical part being deduced from a variation in a position of said peaks.

The first and second piezoelectric transducers may be arranged at two opposite, in said longitudinal direction, ends of the mechanical part.

Another subject of the invention is use of such a method to measure the tightness of a bolt.

Yet another subject of the invention is a system for measuring a variation in a dimension of a mechanical part along a direction called the longitudinal direction, comprising:
a first and second piezoelectric transducer, configured to be fastened in two different positions in said longitudinal direction and acoustically coupled via said mechanical part;
an electronic system configured to determine at least one value of an electric parameter dependent on an off-diagonal term of an impedance matrix of an electric quadrupole modeling the assembly formed by the acoustically coupled first and second piezoelectric transducers; and to deduce, from a variation in said at least one value of said parameter, said variation in the dimension of the mechanical part.

According to some particular embodiments:

Said electronic system may comprise:
a first electronic device configured to apply electric excitation signals to said first piezoelectric transducer and at the same time measure its input impedance;
a second electronic device configured to keep said second piezoelectric transducer successively open circuit and short-circuited; and
a processor configured to drive at least said first electronic device so as to:
apply a first electric excitation signal to said first piezoelectric transducer in order to generate acoustic waves propagating through the mechanical part to the second transducer, while keeping the second piezoelectric transducer open circuit, and measure at the same time the input impedance of said first piezoelectric transducer;
apply a second electric excitation signal to said first piezoelectric transducer in order to generate acoustic waves propagating through the mechanical part to the second transducer, while keeping the second piezoelectric transducer short-circuited, and measure at the same time the input impedance of said first piezoelectric transducer;
calculate the value of said electric parameter from the input impedances thus measured.

The electronic device may be integrated into a system for tightening a bolt, the first and second piezoelectric transducers being configured to be fastened to a said bolt.

Other features, details and advantages of the invention will become apparent on reading the description given with reference to the appended drawings, which are given by way of example and in which:

FIG. 1, which has already been described, illustrates a technique for measuring the length of a mechanical part (bolt) by impedance phase shifting according to the prior art;

FIG. 2, which has already been described, is a graph illustrating the impedance phase shift on which the technique of FIG. 1 is based;

FIG. 3, which has already been described, is a graph illustrating the almost linear relationship between impedance phase shift and tension in the technique of FIG. 1;

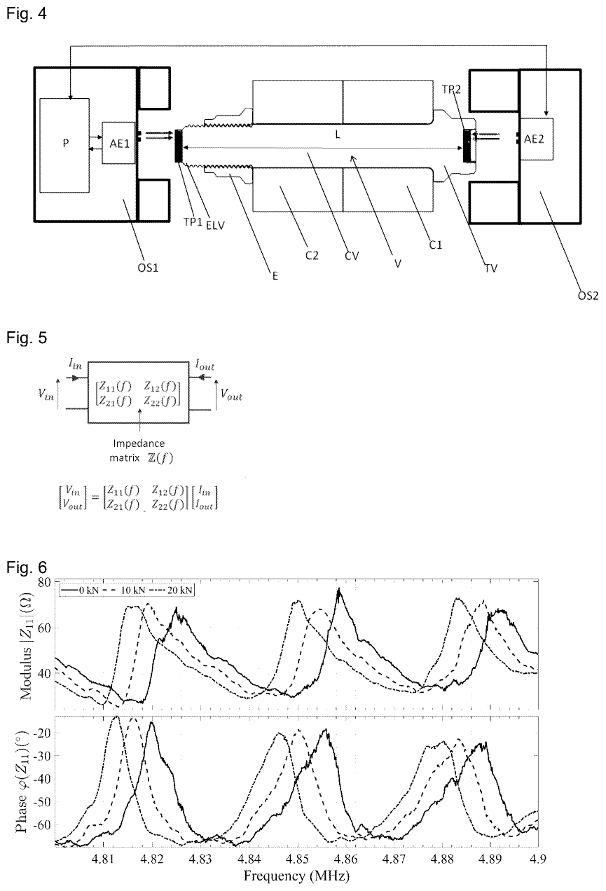

FIG. 4 is the functional schematic of a measuring system according to one embodiment of the invention;

FIG. 5 illustrates modeling of a system of two acoustically coupled piezoelectric transducers by an electric quadrupole;

FIG. 6 is a graph illustrating the variation as a function of frequency in matrix element Z₁₁;

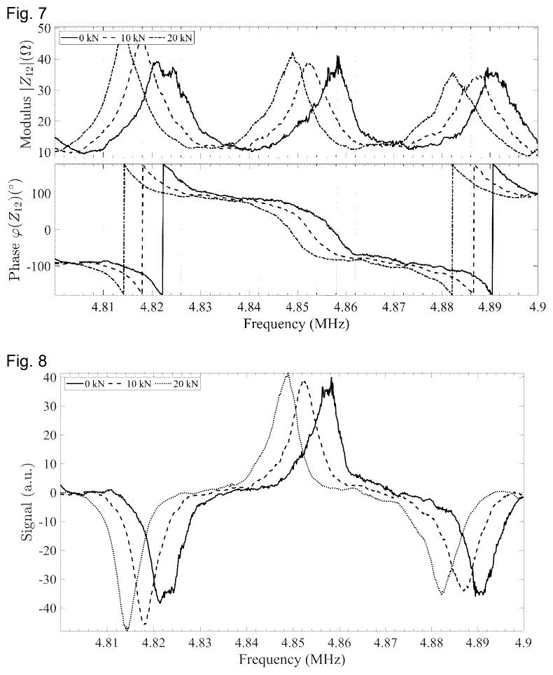

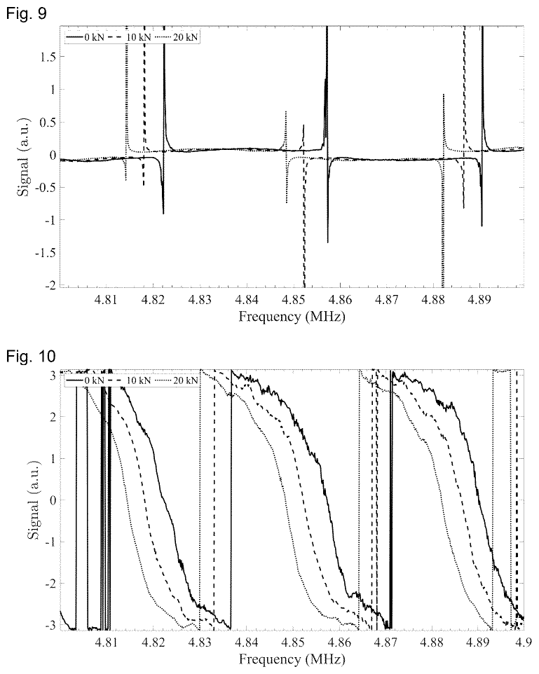

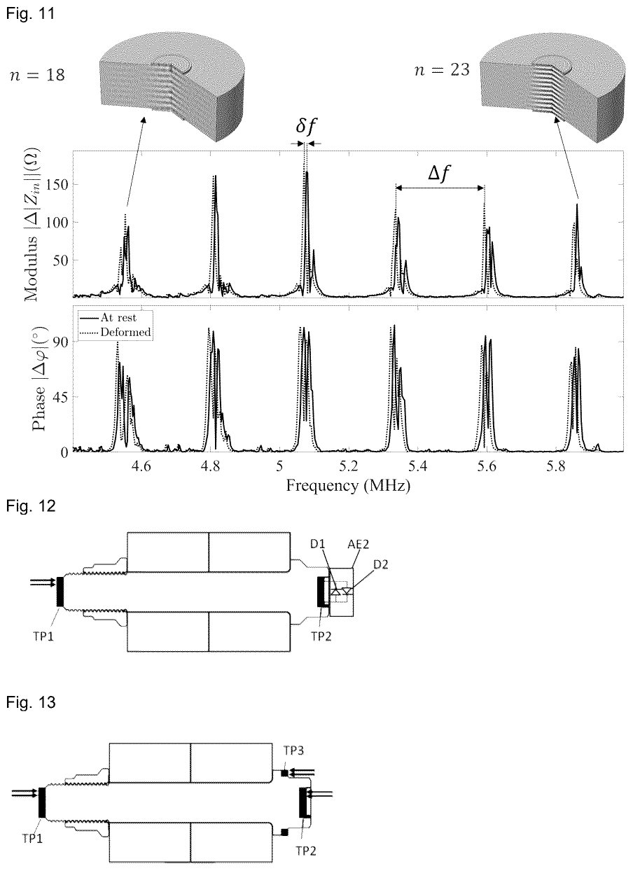

FIG. 7, FIG. 8, FIG. 9, FIG. 10 and FIG. 11 are graphs illustrating the variation as a function of the frequency in various parameters dependent on Z₁₂ that may be used in the implementation of various embodiments of the invention;

FIG. 12 and FIG. 13 are detailed views of two variants of the system of FIG. 4.

In the schematic of FIG. 4 the reference V designates a bolt that extends in a direction called the longitudinal direction x, and that has a length L in that direction. The bolt V has, at one end, a head TV capable of interacting with a tightening tool OS2; the opposite end ELV (free end), which is threaded, is inserted into a nut E, which is also able to interact with a tightening tool OS1. Two mechanical components C1 and C2 are passed through by the bolt body CV and are clamped between the head TV and the nut E. By turning the nut with the tightening tool OS1 while keeping the head TV stationary with the tool OS2, or vice versa, the body of the bolt is tensioned, producing a slight elongation of the bolt body.

To measure this elongation, the bolt V is equipped with two piezoelectric transducers TP1 and TP2, which are arranged on its free end ELV and on its head TV, respectively.

The tightening tools OS1 and OS2, which together form a tightening system, are configured to interact with a respective transducer via electric contacts. More particularly, in the embodiment of FIG. 4, the first tightening tool OS1 comprises a first electronic device AE1, a vector network analyzer, allowing the first piezoelectric transducer TP1 to be excited with a sinusoidal electric signal of variable frequency, and at the same time its complex impedance to be measured. The second tightening tool OS2 in turn comprises a second electronic device AE1 allowing the first piezoelectric transducer TP1 to be excited with a sinusoidal electric signal of variable frequency and/or at the same time its complex impedance to be measured, or indeed a variable load to be applied to it (for example, alternatively a short-circuit and an open circuit). A processor P, for example integrated into the first tightening tool, controls the two electronic devices and receives the impedance measurements taken thereby.

As illustrated in FIG. 5, the assembly consisting of the two transducers acoustically coupled by the body of the bolt V may be modeled by an electric quadrupole, characterized by an impedance matrix Z, characterized by four complex frequency-dependent elements: Z₁₁(f), Z₁₂(f)=Z₂₁(f), Z₂₂(f). If Vin is the voltage applied across the terminals of the transducer TP1, Iᵢₙ the current flowing through said transducer, Vₒᵤₜ the voltage across the terminals of the transducer TP2 and Iₒᵤₜ the current flowing through the latter, then:

$$\{ \begin{matrix}{V}_{in} = {Z}_{11} {I}_{in} + {Z}_{12} {I}_{out} \\ {V}_{out} = {Z}_{12} {I}_{in} + {Z}_{22} {I}_{out}\end{matrix} \qquad ( 1 )$$

As mentioned above, one idea behind the invention is to monitor the variation in at least one parameter P dependent on Z₁₂ and to deduce therefrom a measurement of the variation in a dimension of the mechanical part. This parameter P may be observed at a set frequency or over a frequency spectrum. Likewise, the frequency corresponding to a set value of this parameter P may be monitored over time.

Monitoring a parameter P dependent on Z₁₂, instead of the impedance of a single transducer, has a number of advantages. Specifically, such a parameter may exhibit greater variations in terms of modulus and in terms of phase (which varies from −180° to +180°) and, in certain cases, narrow peaks or abrupt variations, which are easily identifiable. In addition, Z₁₂ is mainly related to the direct path between the two transducers, this making it possible to avoid standing waves that might be set up with other surfaces in the case of a single transducer.

FIG. 6, which is given by way of reference, illustrates the variation in the modulus (top panel) and phase (bottom panel) for three bolt tension values: 0 kN (rest), 10 kN and 20 kN.

FIG. 7 illustrates the variation, under the same conditions, in the parameter Z₁₂. Note the greater amplitude of relative variation in the modulus, and the fact that the phase varies between −180° and +180°, compared with a variation of about 60° in the phase of Z₁₁.

FIG. 8 illustrates the variation, under the same conditions, of the real part of Z₁₂. The presence of narrow peaks, the movement of which with voltage may be tracked by peak-detection algorithms, will be noted.

FIG. 9 illustrates the variation, under the same conditions, of the imaginary part of Z₁₂. This parameter remains close to zero over a large part of the frequency range of interest, but exhibits abrupt changes at resonant frequencies. These changes may be detected by signal-reversal algorithms.

FIG. 10 illustrates the variation, under the same conditions, in the phase

$$arg \frac{{Z}_{12}^{2}}{{Z}_{22 {Z}_{22}}} .$$

Note the substantial variations, which may be tracked by zero-crossing algorithms for example.

One particularly advantageous embodiment is that in which the excitation and impedance measurement are performed on one side only, for example that of TP1. In this case, the second electronic device merely keeps the second transducer TP2 alternately short-circuited and open circuit.

When AP2 keeps the transducer TP2 short-circuited, Vₒᵤₜ=0. Equation (1) therefore becomes:

$$\{ \begin{matrix}{V}_{in} = {Z}_{11} {I}_{in} + {Z}_{12} {I}_{out} \\ 0 = {Z}_{12} {I}_{in} + {Z}_{22} {I}_{out} ⇒ {I}_{out} = - \frac{{Z}_{12}}{{Z}_{22}} {I}_{in}\end{matrix} ⇒ {V}_{in} = ( {Z}_{11} - \frac{{Z}_{12}^{2}}{{Z}_{22}} ) {I}_{in} = {Z}_{11} ( 1 - {ζ}^{2} ) {I}_{in} \qquad ( 2 )$$

with

$$ζ = \frac{{Z}_{12}}{\sqrt{{Z}_{11} {Z}_{22}}} .$$

The input impedance measured under short-circuit conditions

$${Z}_{in}^{sc} = \frac{{V}_{in}}{{I}_{in}} {\vert}_{{V}_{out} = 0}$$

is therefore equal to:

$${{Z}_{in}}^{sc} = {Z}_{11} ( 1 - ζ ) . \qquad ( 3 )$$

When AP2 keeps the transducer TP2 open circuit, Iₒᵤₜ=0. Equation (1) therefore becomes:

$$\{ \begin{matrix}{V}_{in} = {Z}_{11} {I}_{in} \\ {V}_{out} = {Z}_{12} {I}_{in}\end{matrix} \qquad ( 4 )$$

The input impedance measured under open-circuit conditions

$${{Z}_{in}}^{oc} = \frac{{V}_{in}}{{I}_{in}} {\vert}_{{I}_{out} = 0}$$

is therefore quite simply equal to:

$${{Z}_{in}}^{oc} = {Z}_{11} \qquad ( 5 )$$

By calculating the difference between the impedance values it is possible to determine:

$$Δ {Z}_{in} = {{Z}_{in}}^{oc} - {{Z}_{in}}^{sc} = {Z}_{11} {ζ}^{2} = {Z}_{11} \frac{{{Z}_{12}}^{2}}{{Z}_{11} {Z}_{22}} = \frac{{{Z}_{12}}^{2}}{{Z}_{22}} . \qquad ( 6 )$$

The following are also defined:

$$\vert Δ \vert {Z}_{in} \vert \vert = \vert \vert {{Z}_{in}}^{oc} \vert - \vert {{Z}_{in}}^{oc} \vert \vert \qquad ( 7 )$$

$$and$$

$$Δarg ( {Z}_{in} ) = arg ( {{Z}_{in}}^{oc} ) - arg ( {{Z}_{in}}^{sc} ) \qquad ( 8 )$$

FIG. 11 shows graphs of |Δ|Zᵢₙ∥ (upper part) and of |Δ arg(Zᵢₙ)| (lower part) as a function of frequency. It may be seen that the peaks—which correspond to resonant frequencies allowing acoustic standing waves to be set up in the body of the bolt—are much narrower than in the cases of FIG. 2 and FIG. 6; their position may therefore be determined much more accurately. More particularly, in FIG. 11 the solid curve corresponds to a bolt body of length L₀=1 cm at rest and the dotted curve corresponds to the same bolt body stretched by 0.25% (L=1.0036 cm).

The periodicity in frequency of these resonant peaks is denoted Δf and the variation in their position following a variation in the length of the bolt is denoted δf.

The wavelength of an acoustic wave of frequency f is given by

$$λ = \frac{c}{f} ,$$

with c the speed of the wave. The condition for obtaining the standing wave is given by: nλ=2L, where L is the length of the bolt (the half wavelength and length are multiples). This gives as resonant frequencies

$$f = \frac{n}{2} \frac{c}{L}$$

with n an integer. FIG. 11 shows standing waves for n=18 and n=21, and identifies the corresponding peaks in the impedance Zᵢₙ. The distance between the peaks is therefore given by

$$Δ f = \frac{1}{2} \frac{c}{L} .$$

The positions of the peaks f and their spacing Δf vary with the elongation ΔL=εL.

The speed of sound in a uniform medium is given, to a first approximation (neglecting the acousto-elastic effect) by:

$$c = \sqrt{\frac{E}{ρ} \frac{1 - v}{( 1 + v ) ( 1 - 2 v )}} ,$$

where E is the Young's modulus of the material of the bolt, v its Poisson's ratio and ρ its density, which also varies as a function of elongation (while Young's modulus and Poisson's ratio are considered to remain constant to a first approximation). The variation in volume and therefore in density with deformation is given by:

$$\frac{Δ V}{{V}_{0}} = - \frac{Δρ}{{ρ}_{0}} = ( 1 - 2 v ) ε ,$$

where V₀ and ρ₀ are the volume and density at rest, respectively. The resonant frequencies at rest are given by

$${f}_{0}^{n} = \frac{n}{2} \frac{{c}_{0}}{{L}_{0}} = n Δ {f}_{0} ,$$

where n is an integer index, co the speed of sound in the bolt at rest and Δf₀ the spacing between resonant peaks at rest. Under stretching conditions, the resonant frequencies vary such that:

$$\frac{f}{{f}_{0}} = \frac{1}{( 1 + ε ) \sqrt{( 1 - ( 1 - 2 v ) ε )}} = 1 - \frac{1 + 2 v}{2} ε + o ( {ε}^{2} ) ∼ 1 - 0.79 ε \qquad ( 7 )$$

for a steel with v=0.29. Finally, the variation in the frequency peaks is given by:

$$\frac{δ f}{{f}_{0}} ∼ - \frac{1 + 2 v}{2} ε \qquad ( 8 )$$

$$and$$

$$Δ f = ( 1 - \frac{1 + 2 v}{2} ε ) Δ {f}_{0} . \qquad ( 9 )$$

There is indeed a linear relationship between the variations in the position of the impedance peaks and the variation in the length of the bolt (the length of the bolt itself being directly proportional to the applied tension, provided that the linear elastic limit is not exceeded).

FIG. 12 illustrates one particular embodiment in which the second electronic device AE2 consists merely of two diodes D1 and D2 mounted back-to-back in parallel. When the voltage Vₒᵤₜ generated by the transducer TP2 is lower than the threshold voltage of the diodes, this circuit behaves like an open circuit, whereas when Vₒᵤₜ is much higher than the threshold, it behaves like a short-circuit. It is therefore possible to carry out both types of measurements—open circuit and short-circuited—simply by varying the amplitude of the excitation signal of the first transducer TP1. The advantage of this embodiment is that the second electronic device AE2 is completely passive, and only the tightening tool OS1 need be equipped with electric contacts and high-frequency electronics. This device AE2 may even be permanently encapsulated with the transducer TP2, in which case it is not necessary to have access to the bolt head.

FIG. 13 illustrates yet another embodiment, in which a third piezoelectric transducer TP3 is arranged on a flange of the bolt head TV. This makes it possible, for example, to determine a variation in the length between TP1 and TP2 (mainly related to the deformation of the bolt and therefore to the applied force) and a variation in the length between TP2 and TP3 (mainly related to a variation in the temperature of the bolt).

The invention has been described with reference to particular embodiments, but variants are possible. For example:
Taking measurements by exciting only TP1 and changing the state of TP2 (open circuit/short-circuit) is an advantageous but not incontestable choice. It would also be possible, for example, to excite TP1 and take a voltage or current measurement at TP2, or vice versa. The main thing is to take measurements allowing an electric parameter dependent on the off-diagonal term Z₁₂ of the impedance matrix of the electric quadrupole modeling the system formed by the coupled piezoelectric sensors to be accessed.
The parameter of interest is typically complex. It is thus possible to take into account its phase (preferred choice for reasons of robustness), its modulus, its real part, its imaginary part or any combination of these values.
Instead of a sinusoidal excitation signal of (continuously or stepwise) variable frequency, it is possible to use a signal containing a plurality of frequency components at the same time, a pulsed signal for example. This makes it possible to speed up the measurement of the variation in length, at the price of more complex electronics, able to generate and process large pulses.
Instead of determining the frequency dependence of the parameter, it is possible to measure the value of the parameter of interest at a single frequency, and deduce a variation in the length of the mechanical part from a variation in this value.

The structure of the tightening system may differ from that of FIG. 4. For example, it is not essential for the processor P to be integrated into a tool OS1. The processor may moreover be implemented using a microprocessor, an ASIC or even an FPGA. It is possible to use two separate processors to control the electronic device EA (and, if necessary, the electronic device DE) and to calculate the variation in length of the part from the acquired electric measurements.

In the example of FIG. 4 and in the example of FIG. 12, it is the transducer located on the side of the free end of the bolt that is excited, and the transducer on the side of the head that is “passive”. The inverse choice is also possible. The transducers may moreover be arranged in various locations.

The part a variation in the length of which is measured need not necessarily be a bolt, or even a fastening element. It may be any mechanical element allowing acoustic standing waves to be set up and to which piezoelectric transducers may be fastened or attached. The variation in length (more generally, dimension) to be measured need not necessarily be caused by a mechanical stress: it may also, for example, be a question of a thermal expansion or of the effect of corrosion.

### REFERENCES

(Heyman 1977): J. S. Heyman, “A CW Ultrasonic Bolt-strain Monitor”, Experimental Mechanics (1977)
(Smith 1980): J. F. Smith and J. D. Greiner, “Stress Measurement and Bolt Tensioning by Ultrasonic Methods”, Journal of Metals (1980)
(Joshi 1984): S. G. Joshi and R. G. Pathare, “Ultrasonic instrument for measuring bolt stress”, Ultrasonics (1984)
(Shao 2016): J. Shao et al., “Bolt Looseness Detection Based on Piezoelectric Impedance Frequency Shift”, Applied Sciences, vol. 6 (2016)
(Dreisbach 2023): A.-L. Dreisbach and C.-P. Fritzen “A Novel Approach for Preload Monitoring in Bolted Connections Using Electro-Mechanical Impedance Spectra” Lecture Notes in Civil Engineering 254, Springer (2023).

1. A method for measuring a variation in a dimension (L) of a mechanical part (V) along a direction called the longitudinal direction (x), comprising the steps of:
a) providing at least a first and second piezoelectric transducer (TP1, TP2) arranged at two different positions (ELV, TV) along said longitudinal direction and acoustically coupled via said mechanical part;
b) performing, at different times, a plurality of electric measurements in order to determine at least one value of an electric parameter dependent on an off-diagonal term (Z₁₂) of an impedance matrix of an electric quadrupole modeling the assembly formed by the acoustically coupled first and second piezoelectric transducers; and
c) deducing from the results of said electric measurements said variation in the dimension of the mechanical part.

2. The method according to claim 1, wherein each said electric measurement of step b) comprises the sub-steps of:
b1) applying a first electric excitation signal to said first piezoelectric transducer (TP1) in order to generate acoustic waves propagating through the mechanical part to the second transducer (TP2), while keeping the second piezoelectric transducer open circuit, and measuring at the same time the input impedance of said first piezoelectric transducer;
b2) applying a second electric excitation signal to said first piezoelectric transducer (TP1) in order to generate acoustic waves propagating through the mechanical part to the second transducer (TP2), while keeping the second piezoelectric transducer short-circuited, and measuring at the same time the input impedance of said first piezoelectric transducer;
b3) calculating the value of said electric parameter from the input impedances thus measured;
the order of sub-steps b1) and b2) being able to be reversed.

3. The method according to claim 2, wherein said electric parameter is the phase difference of the input impedances measured in sub-steps b1) and b2).

4. The method according to claim 2, wherein the second piezoelectric transducer (TP2) comprises two electric terminals connected together by a pair of back-to-back diodes (D1, D2) in parallel, the first excitation signal being sufficiently weak for the acoustic waves generated to induce, across the terminals of said second piezoelectric transducer, a voltage lower than a threshold of said diodes, which may then be likened to an open circuit, and the second excitation signal being strong enough for the acoustic waves generated to induce, across the terminals of said second piezoelectric transducer, a voltage greater than a threshold of said diodes, which may then be likened to a short-circuit.

5. The method according to claim 1, wherein step b) comprises determining the value of said parameter as a function of frequency.

6. The method according to claim 5, wherein step c) comprises identifying peaks in the value of said electric parameter as a function of frequency, the variation in a dimension of the mechanical part being deduced from a variation in a position of said peaks.

7. The method according to claim 1, wherein the first and second piezoelectric transducers (TP1, TP2) are arranged at two opposite, in said longitudinal direction, ends (ELV, TV) of the mechanical part.

8. Use A use of a method according to claim 1 to measure the tightness of a bolt.

9. A system for measuring a variation in a dimension (L) of a mechanical part (V) along a direction called the longitudinal direction (x), comprising:
a first and second piezoelectric transducer (TP1, TP2), configured to be fastened in two different positions (ELV, TV) in said longitudinal direction and acoustically coupled via said mechanical part;
an electronic system (AE1, AE2, P) configured to determine at least one value of an electric parameter dependent on an off-diagonal term (Z₁₂) of an impedance matrix of an electric quadrupole modeling the assembly formed by the acoustically coupled first and second piezoelectric transducers; and to deduce, from a variation in said at least one value of said parameter, said variation in the dimension of the mechanical part.

10. The measuring system according to claim 9, wherein said electronic system comprises:
a first electronic device (AE1) configured to apply electric excitation signals to said first piezoelectric transducer and at the same time measure its input impedance;
a second electronic device (AE2) configured to keep said second piezoelectric transducer successively open circuit and short-circuited; and
a processor (P) configured to drive at least said first electronic device so as to:
apply a first electric excitation signal to said first piezoelectric transducer (TP1) in order to generate acoustic waves propagating through the mechanical part to the second transducer, while keeping the second piezoelectric transducer (TP2) open circuit, and measure at the same time the input impedance of said first piezoelectric transducer;
apply a second electric excitation signal to said first piezoelectric transducer (TP1) in order to generate acoustic waves propagating through the mechanical part to the second transducer, while keeping the second piezoelectric transducer (TP2) short-circuited, and measure at the same time the input impedance of said first piezoelectric transducer;
calculate the value of said electric parameter from the input impedances thus measured.

11. The measuring system according to claim 9, wherein the electronic device is integrated into a system (OS1, OS2) for tightening a bolt, the first and second piezoelectric transducers being configured to be fastened to a said bolt.
